(19) United States
(12) Patent Application Publication
(10) Pub. No.: US 2011/0275029 A1
(43) Pub. Date: Nov. 10, 2011

(54) DESIGN METHOD OF SURGICAL SCAN TEMPLATES AND IMPROVED TREATMENT PLANNING

(76) Inventor: Fei Gao, (US)

(21) Appl. No.: 12/776,544

(22) Filed: May 10, 2010

(51) Int. Cl. A61C 13/00

(52) U.S. Cl. 433/167

(57) ABSTRACT

In implant dentistry, scan templates, also known as scan appliances or radiographic guides, are fabricated according to patients' anatomy, and later on transferred into surgical guides through CT scan, image segmentation, surface reconstruction, CAD modification, and manufacturing. This approach may be also applied to other kinds of surgery. The final manufactured surgical guides can hardly match the actual geometry of the initial scan templates, thus cannot fit well into patients' mouths, which can pose serious risks for surgery.

This invention introduces calibration features to design and make a scan template, and accordingly the workflow to perform treatment planning with the template. Calibration features are geometric form features or their patterns. Iterations are utilized to make sure the reconstructed model of a scan template can replicate or match with the calibration features. After treatment planning, calibration features are removed from the model (an optional step), and a surgical guide is designed and fabricated. This invention also includes some special calibration feature designs. The treatment planning workflow is greatly improved with calibration features introduced.

### CROSS-REFERENCE TO RELATED APPLICATIONS

Not Applicable.

### REFERENCE CITED

US PATENT DOCUMENTS

| | | |
|---|---|---|
| 5,320,529 | Jun. 14, 1994 | Pompa |
| 5,538,424 | Jul. 27, 1994 | Gelb |
| 5,768,134 | Jun. 16, 1998 | Swaelens, et al. |
| 5,927,982 | Sep. 29, 1998 | Kruger |
| 6,634,883 | Jun. 15, 2001 | Ranalli |
| 6,754,298 | Jul. 4, 2004 | Fessler |

### OTHER PUBLICATIONS

Oyama K, Kan J Y, Kleinman A S, Runcharassaeng K, Lozada J L, Goodacre C J. Misfit of implant fixed complete denture following computer-guided surgery. Int J Oral Maxillofac Implants. 2009 January-February; 24(1):124-30.
Oguz Ozan, Ilser Turkyilmaz, Ahmet Ersan Ersoy, Edwin A. McGlumphy and Stephen F. Rosenstiel. Clinical Accuracy of 3 Different Types of Computed Tomography-Derived Stereolithographic Surgical Guides in Implant Placement. J Oral Maxillofac Surg 67:394-401, 2009.
Giovanni A. P. Di Giacomo, Patricia R. Cury, Ney Soares de Araujo, Wilson R. Sendyk, and Claudio L. Sendyk. Clinical Application of Stereolithographic Surgical Guides for Implant Placement Preliminary Results. J Periodontol. April 2005.
Schneider D, Marquardt P, Zwahlen M, Jung R E. A systematic review on the accuracy and the clinical outcome of computer-guided template-based implant dentistry. Clin Oral Implants Res. 2009 September; 20 Suppl 4:73-86.

### FIELD OF THE INVENTION

Scan templates, or radiographic guides, are used in treatment planning and serve as prototypes for surgical guides that applied onto patients during surgery. This invention involves a method to design scan templates for implant dentistry or for other fields using scan templates similarly. This method and corresponding image processing workflow constitutes a mechanism to ensure that the surface reconstruction of the CT scan of the templates can well replicate the geometry of the physical models, and thus accurately transfer treatment plans onto the surgical guides.

### BACKGROUND OF THE INVENTION

In FIG. 1, the scan template B is a physical model made either directly or indirectly based on the subject's anatomy A. In dental implant planning, this is a scan template that is normally made from plaster model. With latest technology the scan templates can also be directly made from digital files obtained by optical scan.

B is later on scanned into image C through CT, Cone Beam CT or other 3D imaging techniques. Image segmentation is then applied on C to get image D. Surface model E is reconstructed from D, which is expected to be a replica of B. Marching cube is the typical approach to reconstruct this model.

Treatment planning is then conducted with D, E, and the CT scan of A as well. With dental implant planning, the surgeons or technicians decide the position and parameters of implants to be placed on A. The treatment plan is registered with model E. Consequently, functional or geometric features resulted from the plan are added to E and the final result is a surgical device F. F is then manufactured with rapid prototyping or other technology, and applied back onto A at the time surgery is performed. This scheme is basically the depiction of most of the dental implant planning system.

The critical issue to be solved in this procedure is that the surface model E and F can hardly match the actual size of B, while F is expected to be able to fit into the patient's anatomy with acceptable error. U.S. Pat. No. 5,768,134 described a method to make a “perfected” medical model on the basis of image information. Its focus is the manufacturing approach of surgical guides. However, there is no word about how to get the “perfected” model, or why a model is “perfected”, or whether there is even a “perfected” model. Many practitioners and researchers have well noticed the inaccuracy of the surgical guides, but there is only very little research in this area. In a recent published article “A systematic review on the accuracy and the clinical outcome of computer-guided template-based implant dentistry” (Clin Oral Implants Res. 2009 September; 20 Suppl 4:73-86), Schneider D, et al. searched through more than 3000 papers and found only 8 of them related to this accuracy issue. Almost all the papers found related to this topic are experiments to test the accuracy of certain software or process with a small set of cases or models, but no work is found to systematically analyze the reasons of the inaccuracy and the approaches to resolve the issue.

The sources of inaccuracy are listed in the following. The combination of the three aspects can be very difficult to manage and predict.
It is well known that the CT scan image C can barely replicate the dimensions of B. Even though the material of a model is uniform, the CT data around the boundary decrease to the background value in a ‘ramp’ other than immediately, which makes it hard to decide where the boundary actually is. In order to segment D from C, image processing such as thresholding, level set approach, etc. is used to delineate or distinguish the boundary of the object from background pixels. It can be very subjective to label a pixel as boundary or background due to the nature of CT scan data.
Meanwhile the attenuation (U.S. Pat. No. 6,754,298) of X-rays is also a source of errors. Even though many CT manufacturers already implement attenuation correction algorithms in their reconstruction software, we have no idea how good they are. When the CT data is given us, we are lost already in terms of how accurate the image is to reflect pixel locations and density.
Further on, the surface reconstruction step will lead to more errors when interpolating between the foreground and background pixels.

In practice, almost all dental implant planning systems let users adjust thresholds and dynamically update the model accordingly. When the user feels that the model well reflects the actual shape, he/she will stop adjusting the segmentation. However, some systems split this processing from the treatment planning in their deployment. For example, Materialise licenses their software module for so-called DICOM conversion to image centers, where the thresholding and surface reconstruction is done without the participation of dental professionals.

An alternative process to this is to do the treatment planning as described, but design surgical guide with a more accurate model other than E. This is illustrated in FIG. 2. Materialise's implant planning system SimPlant has implemented this scheme. In addition to the CT scan, it does an optical scan G of the scan template assuming the precision of optical scan is much better than CT scan, and then G is used as the base for surgical guide. Another alternative is to directly use model B as the physical base for surgical guide, which has been implemented by Keystone Dental's EasyGuide.

Such processes certainly improve the structural fitting of the surgical guides, but raise other crucial issues. For example, how reliable is the registration between E and G that have different accuracies? How can the treatment plan performed on the less accurate model E be precisely transferred to the more accurate model G?

### BRIEF SUMMARY OF THE INVENTION

The objective of this invention is to provide a solution for these problems. It is developed so that the reconstructed surface model of a template will well replicate its geometry, and serve as a good base for treatment planning and surgical guide fabrication.

This new method is to add calibration features to a scan template. Calibration features are geometric form features and/or their patterns. They must be of the same material as the templates. They have some predefined shapes and parameters, as well as geometric and topological relationships. The reconstruction accuracy of these features can represent that of an entire scan template, which is the essential rationale of this invention.

The workflow of image processing derived from the proposed scan template design is as follows. When the CT data is obtained, image is processed, geometric model is reconstructed, calibration features are recognized, extracted, and registered with their known shape, parameters and relationships. The difference between the extracted model and the actual model is the objective function of the iteration of image processing and surface reconstruction. Once the difference is less than the predefined target, the result of the scan template reconstruction is considered as acceptable.

The derived treatment planning workflow and software system are also part of this invention. Typically, the treatment planning is performed with references to the reconstructed scan template and the patients jawbone structure, 2D slices, etc. The resulted plan will eventually lead to geometric operations to modify the scan template with for example, holes, sleeves, additional materials, etc. With the introduction of calibration features we can be confident that the reconstructed model has good accuracy.

Calibration features can be designed in certain way so that the image processing is easy to implement and more efficient. When the relationships between features are used to assess the reconstruction, there is no need to register with the original shape and parameters of the features. In a specific embodiment, we use the alignment of two faces with opposite direction as the criteria. An interactive software system is developed based on this. Users can dynamically adjust thresholds to filter the image, the system updates the model in real time so that the users can instantly notice that how well the two faces are aligned. When they align well, the users know the reconstruction is good.

### DESCRIPTION OF THE DRAWING

FIG. 1 illustrates the workflow of making and using a scan template for treatment planning. The scan template is made, scanned, reconstructed from 3D image. A surgical device, or surgical guide, is then made from the reconstructed model. The surgical guide is expected to duplicate the size and geometry of the scan template, but actually can barely do so.

FIG. 2 is a modified procedure that uses an optical scan or similar model as the base for the surgical guide. This model is more accurate than the reconstructed model, but the treatment plan is still performed with the reconstructed.

FIG. 3 illustrates the calibration features. Features can be of any known geometries and/or their patterns.

FIG. 4 is the workflow to reconstruct scan template surface model with the calibration features.

FIG. 5, 6 illustrates the two special designs of calibration features, which can make the workflow more efficient and simpler.

### DETAILED DESCRIPTION OF THE INVENTION THE INVENTION

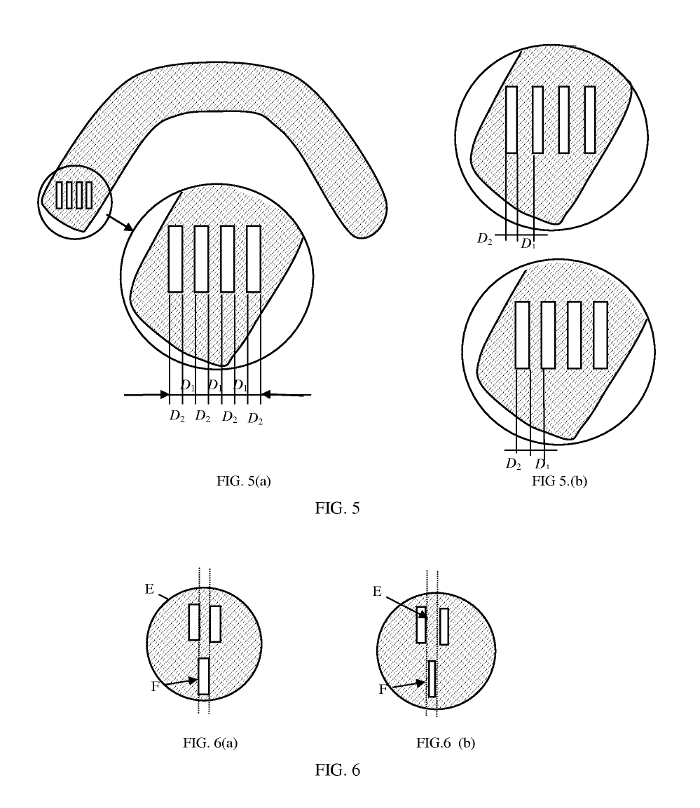

In order for a computer software system to reconstruct scan template models with good accuracy, one or more geometric form features of known parameters, or a pattern of form features, are added to the scan template. They are referred as calibration features. The features can be positive, negative, or their combinations. Positive features are material-added, such as bosses and ribs. Negative ones are holes, pockets, slots and the like. FIG. 4 shows a few examples. As an integral part of a scan template, features must have the same material as the template.

The idea behind the calibration feature is that when the features as part of a template are segmented and reconstructed with good accuracy, the template will also have good accuracy. This comes with two constraints. First, the material has to be same and uniform. Secondly, for scan templates, what really matters the most is the thickness of the reconstructed model. When the calibration features are used to evaluate the reconstruction, we typically use one or more dimensions as the criteria. In order for them to well represent the scan template, these dimensions need to be close to the thickness of the scan template.

There are two categories of calibration features and corresponding processing. The first category is to have independent features that have accurately known parameters and shapes. The image processing of the scan data of the template will try to replicate them. The algorithm is as following: First, segment the scan image using filters like thresholding. Secondly, recognize the form features or patterns by employing a specific procedure, and extract the geometry of the features. Next, register the features with known shape and parameters, and evaluate the difference. If the difference is bigger than a predefined value, go to the first step to adjust the segmentation parameters until the error is acceptable. When the errors of the form features are acceptable, the scan template segmentation and reconstruction is considered good. This workflow is illustrated in FIG. 4.

The second category is to add form features with some known relationships, i.e., some special conditions among the added features, which will be met when the process of segmentation and reconstruction produces good results. Its difference from the first category is that these features are self-sufficient for verifying if the accuracy is good, the parameters of the features are not important, and thus it is not necessary to do a registration against the nominal shape of the features.

In a specific embodiment, FIG. 5 (a) shows an example of such design. An evenly distributed set of slots is added to the scan template. Dimension D₁ is referred as positive dimension, and D₂ negative. The slots are designed so that D₁=D₂. Simple thresholding is used for segmentation. FIG. 5(b) shows the reconstructed models with different threshold values. When D₁=D₂, i.e., the reconstructed positive dimension equals to the negative, we know the thresholds are good. When D₁>D₂, too many pixels are included. When D₁<D₂, too many excluded. With such features, we do not need their parameters to assess the accuracy. The relationships among them serve as the criteria.

The workflow for such an approach is simpler than the first. The feature registration and comparison in the FIG. 4 is not necessary for this workflow. Instead, the feature relationships are identified and validated.

After the image processing, the surface model with those features are obtained. This model, together with the patient scan image, serves as the base for treatment planning, and surgical guide design and manufacturing.

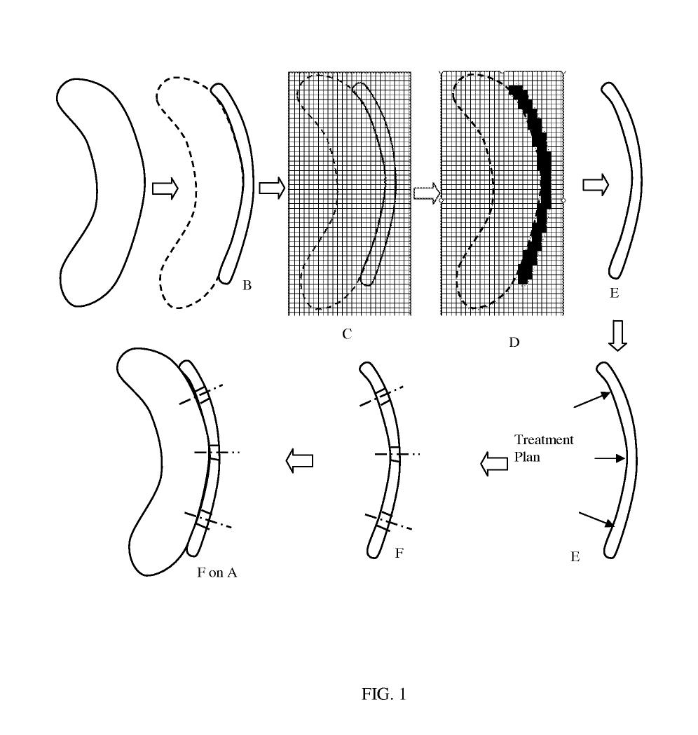

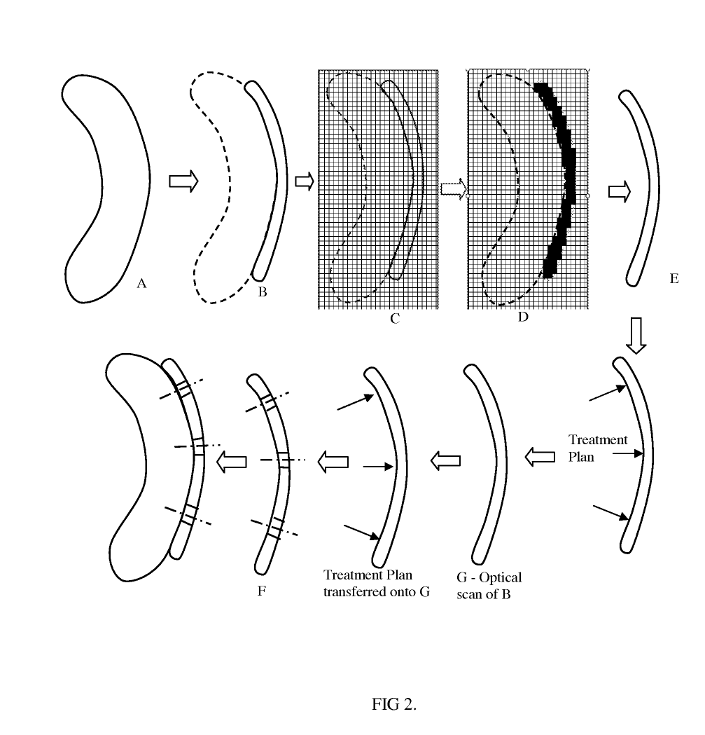

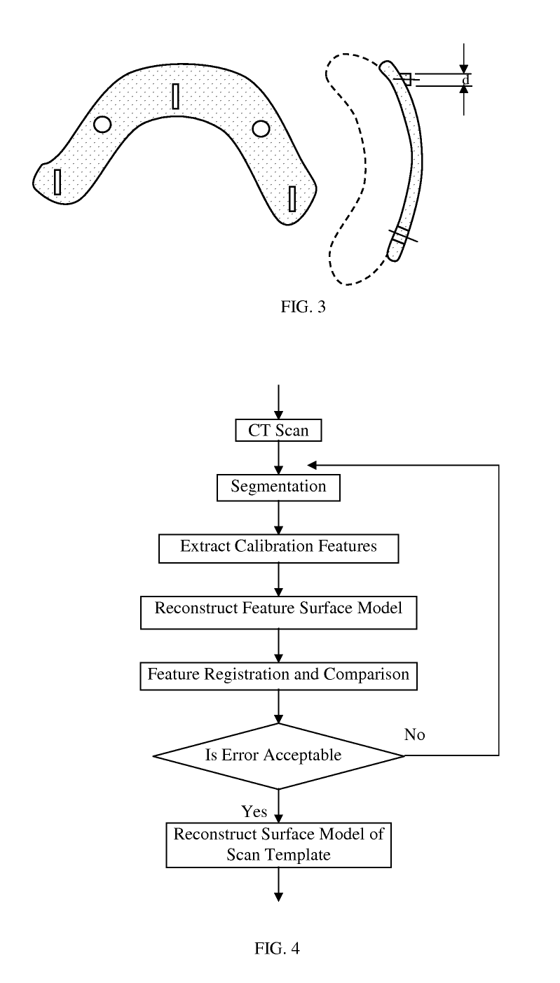

Both the workflows illustrated in FIGS. 1 and 2 can be improved by the introduction of calibration features. In a process like FIG. 1, the scan template now can be reconstructed with the right parameters and can be expected to fit well with the subject's anatomy. With this invention applied in the second workflow, the reconstructed model is more accurate, thus one can be more confident that the treatment plan created on the reconstructed model will be correctly mapped onto the optical scan or physical model of the scan template, and then surgical guide.

The next step, optionally, in the surgical guide design is to remove the added features before being sent to manufacturing. Once we have the resulted models in good accuracy, we don't want to have the calibration features remain. Geometric modeling operations are applied onto the surface model so that the added features are removed, and a duplicate of the scan template without those form features are achieved. As a result, the eventual surgical guide will come out clean without the presence of the calibration features.

It is important that the calibration features have to be the same materials as the scan template itself. Prior art like the so-called X-marker from Keystone is for the purpose to manufacture surgical guide (http://www.keystonedental.com/easyguide/Xmarker/). Conventional radio-opaque landmarks using glass beads, gutta percha, etc like in U.S. Pat. No. 5,927,982 are used for different purposes other than what is interested in this invention.

### Embodiments

There is a correlation between the design of calibration features and the image processing. For different features and their patterns there are different image processing workflow. In a specific embodiment, the scan template is added a simple form feature, such as a cylindrical hole or boss. The segmentation will be simple thresholding. The evaluation of the segmentation will include steps to identify the hole, extract the hole diameter, and compare with the known diameter.

CT scan itself may not obtain uniform results across the board, so another embodiment is to have more than one calibration features distributed on the model. The features can have different type and parameters. The evaluation of the segmentation is essentially an optimization procedure taking the average reconstruction errors of those features as objective function.

In another category of embodiments that feature relationships are used as the criteria, the calibration features and their patterns can be designed in such a way that image processing in the second step can be greatly simplified. FIG. 6(a) is another embodiment of this approach. Slots are used as calibration features. They are placed so that face E is coplanar with F. When the thresholds used to segment the model is not good, the reconstructed E and F are not coplanar. FIG. 6(b) illustrates a possible reconstruction, where not enough pixels are excluded and the resulted model is too bulky.

The workflow for this specific embodiment can be an interactive software system. The users interactively adjust the thresholds of the segmentation; the filtered image or reconstructed models are dynamically updated with the thresholds. In the meantime, the users can visually check the alignment of the faces, or use some helper widgets (lines, planes, etc) for this purpose. When the users find the alignments are good, the segmentation and reconstruction converge to an acceptable result.

What is claimed is:

1. The method to design and make scan template with calibration features, which must be same material as the scan template itself and are used to evaluate the accuracy of the image processing and model reconstruction.

2. The method according to claim 1, wherein one or more form features with known shapes and parameters are used as calibration features.

3. The method according to claim 1, wherein form features with some known geometric or topological relationships are used as calibration features, the satisfaction of the which will be used to evaluate the results.

4. An embodiment according to claim 3, wherein an evenly distributed set of slots is used as calibration features, which has one or more positive dimensions and one or more negative dimensions, and the satisfaction of certain specific relationships between the dimensions is the criteria to accept the results.

5. Another embodiment of claim 3 as well as its variants, where calibration features are added so that two faces facing opposite directions are aligned.

6. The treatment planning workflow, wherein the image processing and model reconstruction of a scan template designed and made according to claim 1, or specifically claim 2 or 3, is performed in an iterative way until the reconstructed model of the calibration features converge to their original known shape with embodiments of claim 2, or until the feature relationships are met as embodiments of claim 3.

7. A software system according to claim 1 and 6, wherein the calibration features are identified, evaluated, the image processing is iterated, and the treatment planning is performed with references to the segmented and reconstructed model.

8. A software system according to claim 1, which includes the use of scan templates made according to claim 4 or 5, one or more interactive tools or filters to segment the model, the dynamic system update of the filtered model, and a mechanism to visually check if results meet the criteria specified for claim 4 or 5.
